(19) United States
(12) Patent Application Publication
(10) Pub. No.: US 2008/0094476 A1
(43) Pub. Date: Apr. 24, 2008

(54) System and Method of High-Speed Image-Cued Triggering

(75) Inventors: Charles A. Whitehead, Madison, AL (US); Gregory J. Wirth, Madison, AL (US)

Correspondence Address: LANIER FORD SHAVER & PAYNE P.C., P O BOX 2087, HUNTSVILLE, AL, 35804-2087, US

(73) Assignee: SOUTHERN VISION SYSTEMS, INC., Madison, AL (US)

(21) Appl. No.: 11/960,857

(22) Filed: Dec. 20, 2007

Related U.S. Application Data
(63) Continuation-in-part of application No. 11/582,892, filed on Oct. 18, 2006.

(51) Int. Cl. H04N 5/225

(52) U.S. Cl. 348/207.1

(57) ABSTRACT

A high-speed digital camera system and method for processing high-speed image data is claimed. The method comprises generating images with at least 3×10⁵ pixels at greater than 60 frames-per-second with an image sensor, downloading an image; defining an area of interest in the downloaded image comprising a plurality of adjacent pixels in which an event of interest is expected to occur, defining at least one threshold level for all pixels in the plurality; uploading the defined threshold level to a processor, retrieving pixel data in real time from the image sensor, and comparing the pixel data to the defined threshold levels. A trigger is set when the threshold levels are exceeded and the camera records the event of interest and stores it in camera memory for outputting to a remote computer.

### REFERENCE TO RELATED APPLICATIONS

This application is a continuation-in-part of and claims priority to Non-provisional patent application U.S. Ser. No. 11/582,892, entitled “System and Method of High-Speed Image-Cued Triggering” and filed on Oct. 18, 2006, which is fully incorporated herein by reference.

### FIELD OF THE INVENTION

The present invention relates generally to the field of high-speed “smart” digital cameras, and specifically to a method of assessing imagery real-time in order to determine subsequent processing tasks to be performed inside the camera at frame-rates in excess of 60 Hz.

### BACKGROUND OF THE INVENTION

Digital cameras using rectangular arrays of photo-detector picture elements (pixels) are well-known in the art and are replacing film cameras in the fields of motion capture, bio-analysis, ordnance characterization, and missile development. Digital storage devices currently allow storage of terabyte (10¹² bytes) size files resulting in several minutes to hours of high-speed video. Digital cameras have numerous advantages over film cameras including the ability to display the imagery within a few seconds after recording. However, the costs associated with digital memory make long-time storage too expensive for many applications.

High-speed imagers typically have frame-rates of greater than 60 Hz and recent advances in semiconductor technology have enabled frame sizes of greater than one million pixels. Large-area field-programmable gate arrays have only recently achieved the speed and gate-count to control, direct, and store mega-pixel images at greater than 60 Hz frame-rate. High-speed digital cameras have limited on-board storage capacity because of the high rate of data transfer and because of the size, power consumption, and cost associated with available digital memories. In addition, even though the camera stores the entire image, there is relevant information in only a part of the image, leading to inefficient use of memory. High-speed digital cameras are especially impacted by this inefficiency because of the large data-rates needed for transferring imagery and the high costs of digital storage. A critical need in this arena is a “smart” high-speed camera that can make an assessment on a frame-by-frame basis of whether an image has relevant information and where the information is located within the image thereby storing only the frames or portion of frames that are of interest.

Another need is for a high-speed digital camera in which image acquisition, processing, and storage are all performed inside one enclosure, thereby reducing noise and complexity of installation, operation, and troubleshooting. Alternatively, the image acquisition and processing may be in one camera enclosure, and the “large memory” required for storing imaged data may be housed in auxiliary equipment.

In addition, digital cameras used with conventional proximity sensors risk missing an event of interest. It would be desirable to have events of interest sensed based on information within the camera in order to increase the dynamic range, sensitivity, discrimination, and resolution of the sensing process.

It is therefore an object of the present invention to provide a high-speed digital camera that samples imagery real-time and records only those frames or sequences of frames that are relevant, thus extending recording time over cameras with the same memory capacities.

It is another object of the present invention to provide a high-speed digital camera in which image acquisition, processing, and storage may all be performed inside one enclosure.

It is yet another object of the present invention to provide a camera that reduces the risk of missing an event-of-interest by sensing the event based on information within the camera, rather than utilizing external sensing means.

It is another object of the present invention to reduce the possibility of false positives detected by a digital camera in autonomous-sensing mode.

### SUMMARY OF THE INVENTION

The present invention achieves these objectives by providing a system and method to sample high-speed imagery (generally greater than 60 fps of greater than 3×10⁵ pixels) as it is acquired and generate a trigger within the camera based on the information content in an image before the next image is acquired. Such a trigger will be termed an “image-cued trigger.” This image-cued trigger is used by the camera to start or stop the recording process. In the preferred embodiment, images are recorded from the imager to circular-buffer memory within the camera enclosure. The image-cued trigger can also designate X frames before the trigger and Y frames after the trigger to be stored for replay where X+Y is the total number of frames capable of fitting into the available on-board memory. The image-cued trigger can also be used as a flag to store or discard each individual image.

The present invention achieves these objectives by providing a system and method that senses the event with the same device used for recording, in which the trigger event is also recorded and may be reviewed for diagnostic purposes. The triggering event as determined by the image-cued trigger of the present invention can be discriminated over two spatial axes versus time unlike audio or proximity sensors whose signal is discriminated over one signal axis versus time. This additional axis of discrimination provides a higher level of reliability in triggering.

The system and method according to the present invention also minimizes false positives by defining two image-cued windows, an arming sequence, and a maximum delay between observed events in each window.

The present invention applies to self-contained image-acquisition systems (cameras) that may include large memory within the camera housing. During operation, imagery is recorded at a high (>60 fps) rate into the on-board large memory and subsequently transferred down a standard (e.g. USB, Firewire, Serial, Ethernet) digital interface at a lower rate. Alternatively, data may be written directly to external memory.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### DESCRIPTION OF THE DRAWINGS

FIG. 1 is block diagram illustrating a system in accordance with an exemplary embodiment of the present disclosure.

FIG. 2 is an exemplary representation of a data window into which parameters for image-cued triggering are input by a user.

FIG. 3 is a block diagram illustrating a system in accordance with an exemplary embodiment of the present disclosure.

FIG. 4 is a flow chart illustrating exemplary architecture and functionality of the system illustrated in FIG. 3.

Repeat use of reference characters throughout the present specification and appended drawings is intended to represent the same or analogous features or elements of the invention.

### DETAILED DESCRIPTION

The present invention and its advantages are best understood by referring to the drawings. The elements of the drawings are not necessarily to scale, emphasis instead being placed upon clearly illustrating the principles of the invention.

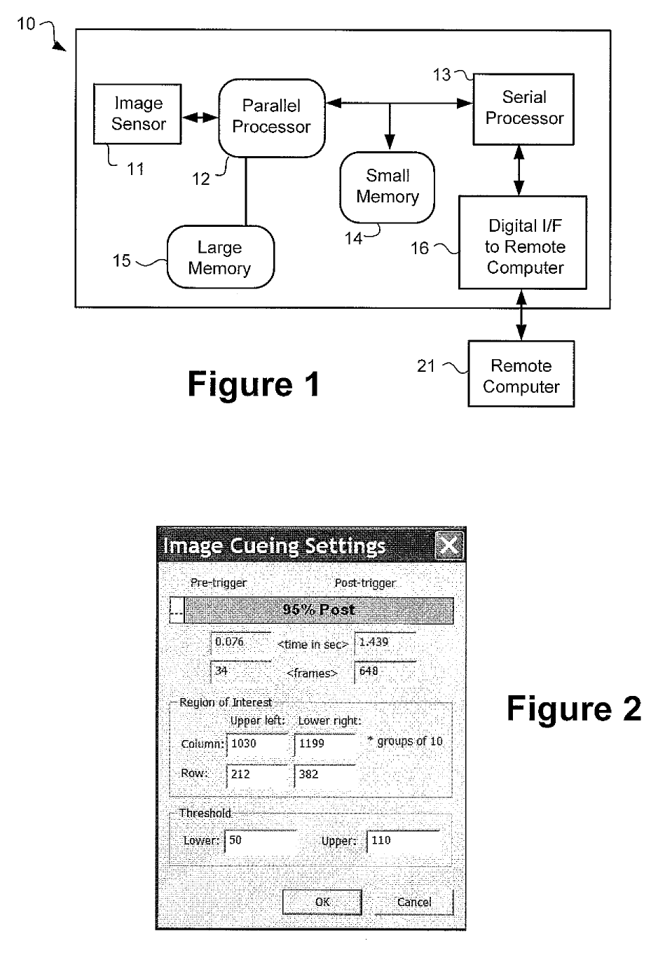

One embodiment of the camera 10 is represented schematically in FIG. 1. Parallel processor 12 and serial processor 13 perform the processing functions for the camera 10. There are two common techniques for processing high-speed imagery: “pipeline” and “parallel.” The pipeline technique adds latency to the processing time by requiring that the “pipeline” be filled before processing begins. Once filled, each sequential operation on the pipeline represents final processing of an image pixel. The parallel technique utilizes multiple processors running in parallel to accomplish image processing. An extreme example of this is a processor for each image pixel. However, this is unrealistic given the status of current technology, and some reasonable number of parallel processors is designated to reach target image processing speeds. For large image arrays (>3×10⁵) at high frame-rates (>60 Hz), a combination of pipeline and parallel architectures is required for the common image processing tasks, and parallel processor 12 and serial processor 13 perform these functions.

In FIG. 1, parallel processor 12 and serial processor 13 are shown as separate components, but the processing capability may also be provided by a single processing device. For example, the functionality of both parallel and serial processing capability may be achieved by using a large area field-programmable gate array (“FPGA”) such as the Xilinx Virtex FPGA with an embedded PowerPC module. Other processing devices, such as field-programmable object arrays (“FPOAs”), could be used instead.

In the illustrated embodiment, a small memory module 14 of typically less than 1 gigabyte is used to perform various functions such as buffering data packets for transmission over a digital interface, storing masks for image processing, and/or temporary storage of frames when acquiring imagery or retrieving stored frames from main camera memory. 4 MB of SRAM memory is used in one embodiment, though other types of memory may be used instead.

The primary or large camera memory 15 in this embodiment can be achieved using Dual Inline Memory Modules (DIMM) that can range in value from 4 MB to 64 GB. DIMM may consist of flash chips, SRAM, DRAM, or SDRAM. These types of memory are relatively inexpensive and common to the industry, though other forms of large memory may be used in other embodiments of the invention. If further storage is needed, a system of distributed disk drives external to the camera (not illustrated) is commonly used to achieve terabyte storage capacity.

In one embodiment of the invention, the parallel processor 12 provides the control signals to acquire an image from the image sensor 11, which in the preferred embodiment is a CMOS imager. Images are acquired from the CMOS imager on a pixel-by-pixel basis. Because of the time required to retrieve one row of an image from the imager, the parallel processor 12 and serial processor 13 have additional processing cycles at their disposal for adding, subtracting, multiplying, counting, and/or comparing pixel values. This excess processing margin enables the functions described in this patent. Both processors generally operate in a “pipelined” fashion in order to meet speed requirements. Internal parallel processor memory (not illustrated) is used to store threshold or comparator values with which each pixel is compared as it comes off the CMOS imager. If the pixel value is below a lower threshold or above an upper threshold, then the processor generates a trigger that starts or stops the recording process. This trigger can also be used to set a flag that controls whether each frame of the imagery is stored in large memory or discarded.

During autonomous image-cued trigger operation, the user pre-defines via remote computer 21 an image-cued window (“ICW”) in the field-of-view of the camera 10 in which an event is expected to occur. For the purposes of this specification, the term “event of interest” or “expected event” refers to the high-speed event that is intended to be recorded (for example, a rocket launch). In one embodiment of the invention, the user can define the ICW either by dragging a mouse over an area of the image or by manually entering the upper-left/lower-right pixels from a remote computer. The ICW may be an area from 10×10 pixels to 1280×1024 pixels in one embodiment of the invention. Based on the quiescent pixel values in this ICW, the user defines upper and lower thresholds that are nominally 10-20% lower and higher, respectively, than the minimum and maximum quiescent pixel values. Motion in this ICW is interpreted as a dynamic change in grayscale value. The event to record is anticipated to produce at least one pixel grayscale value that drops below or exceeds these threshold values. The parallel processor 12 compares each pixel in this area of interest (“AOI”) against an upper and lower threshold to determine whether the event has occurred. If any pixel grayscale value in this AOI either drops below the lower threshold or exceeds the upper threshold, an event is assumed to occur and a trigger is generated. With both upper and lower thresholds, a light object against a dark background moving into the image-cued window can be distinguished just as easily as a dark object against a light background. There are, however, applications in which a user may want only an upper or a lower threshold set, instead of both an upper and lower, and those applications are also within the scope of the present invention.

By way of example, FIG. 2 illustrates a data window that is configured to allow image cueing settings to be manually input by a user of the present invention. In this example, the user defined an ICW by inputting the upper left pixel row 1030 and column 212 and lower right pixel row 1199 and column 382. The software then reports for the defined ICW the absolute minimum and maximum pixel values present. If the minimum and maximum pixel values are 60 and 100, then a user may choose to set the lower trigger threshold level at 50 and the upper trigger threshold level at 110, as shown in FIG. 2. With these settings input, a trigger would be generated if any pixel in the image-cued area has a signal level below 50 or above 110.

As discussed above, the image-cued trigger may be used to start the recording process in the large memory, i.e., to cause the large memory 15 to stop overwriting the data being recorded in circular buffer fashion and to record the predetermined pre- and post-trigger sequences for downloading to a host computer.

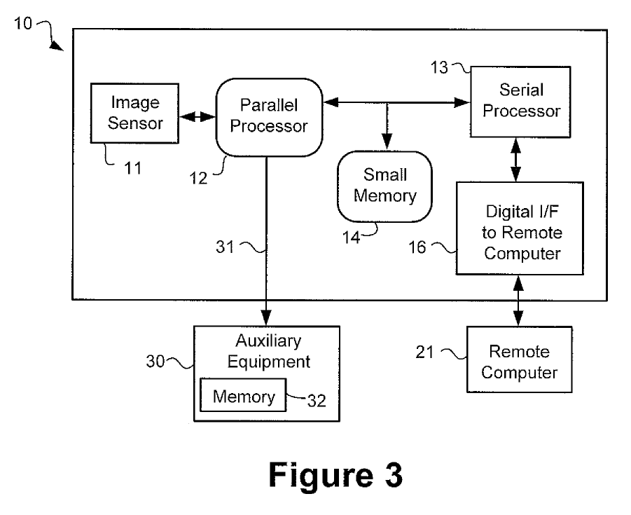

As illustrated in FIG. 3, in one embodiment of the invention the image-cued trigger may be output directly to auxiliary equipment 30 external to the camera 10. In this embodiment, the image-cued trigger generated by camera 10 triggers operation of the auxiliary equipment 30. For example, auxiliary equipment 30 may be an external camera that starts recording when it receives a trigger from camera 10. Other examples of auxiliary equipment 30 include hyper-spectral sensors, multi-axis accelerometers, and/or an I/O board that starts or stops recording analog voltage levels when an event is recognized. In this embodiment, camera 10 does not contain its own large memory, but rather utilizes external memory 32 resident in auxiliary equipment 30.

The invention also permits the user to set how much of the allowable memory will be used to record the event post-trigger versus pre-trigger. In the example illustrated in FIG. 2, the user has configured the camera to record 95% post-trigger. This means that once the trigger is generated, 5% of the available memory will be filled with frames occurring before the trigger and 95% of available memory will be filled with post-trigger frames. During playback, the values in the image-cued trigger region can be observed on a frame-by-frame basis. This allows the user to determine exactly which frame generated the trigger.

In addition to the image-cued triggering as discussed herein, some embodiments of the present invention provide for triggering the recording process from an external trigger source. As with the image-cued triggering, the user can input the desired pre- and post-trigger recording percentages. In addition, the user specifies whether the recording should be triggered off the rising or falling edge of the trigger pulse. A user-defined delay determines how long after the trigger edge the first frame is captured. This delay typically ranges from 0.002 to 60,000 milliseconds and can be used in conjunction with the pre- and post-trigger settings. The external trigger is input to the camera in the form of a TTL pulse.

Another trigger option provided by the camera is a “frame sync” mode. In frame-synch mode, a trigger causes a single frame to be captured. In order to fill up the memory in frame-synch mode, the camera must see multiple trigger pulses. For example, filling up a 16 GB camera with mega-pixel imagery would require 16,000 triggers each resulting in one image being stored. Once memory is full, the record process is stopped and frames can be downloaded. The frame sync mode works with an external TTL trigger pulse or with image-cued trigger. Prior art high-speed cameras have an image-cued trigger that samples one row out of the image at very high speed on a camera that has no large memory on board. When the pixels in that one row exceed a threshold condition, then the next frame is captured and stored. The frame sync mode of the present invention differs from the operation of the prior art cameras in that the actual frame that generates the trigger is the one stored.

The anticipated time-rate-of-change of pixel signal levels in the ICW can also be an important parameter in the operation of the present invention. The user defines this parameter based upon the anticipated event to be recorded. This parameter may be used by the camera to distinguish between changes in pixel levels based upon the actual anticipated high-speed event and changes in pixel levels that can be caused by slowly varying intensity levels over time (e.g., the sun going behind a cloud). The camera has an auto-exposure feature that samples the average intensity of each image during the recording process and varies the electronic shutter between each consecutive frame to keep the average intensity close to the target average intensity. The auto-exposure feature has its own trigger based upon a slow rate of change, while the image-cued trigger operates at a much faster rate of change. The triggered time-rate-of-change of pixel signal levels for the auto-exposure feature is typically ≦5% of the pixel signal level from one frame to the next. For image-cued trigger operation, the typical time-rate-of-change per frame is ≧10%.

Because the image-cued trigger as discussed above may be susceptible to false positives such as a glint of sunlight, bird, car, or other interference, one embodiment of the invention utilizes two ICW's to reduce or eliminate the possibility of false positives. In the case of a false positive, thresholds defining an image-cued event are exceeded by something other than the event of interest. As a method of greatly reducing false positive image-cued triggers, this embodiment has two separate, independent image-cued windows—one of which has to be armed before the other can generate the trigger. Both image-cued windows generally have upper and lower thresholds for each pixel. However, an out-of-threshold event in the second ICW does not generate a trigger unless the first ICW has already seen its event. In this manner, a bird flying through the field of view left-to-right would not trigger image-cued settings for a missile flying right-to-left. Similarly, an out-of-threshold event in the first ICW that is not observed in the second ICW will not generate a trigger; nor will an event that is observed only in the second ICW. Three or more ICW's may also be used in a similar manner.

The anticipated time-rate-of-change is used in the two-ICW configuration to define the delay maximum delay between the first and second ICW events, after which a spurious event is assumed and both are armed again. Typical delays are a few hundred microseconds to several milliseconds. Similarly, the second ICW would be re-armed after a spurious event observed only in it. Using this feature would eliminate false triggers by events that occur outside of the anticipated time-rate-of-change window. For example a bird flying through the image cued windows in the proper order would take longer then the maximum delay that was set for a missile launch and would therefore not cause a trigger.

Various functions can be implemented on each pixel or row of pixels before the next pixel or row of pixels is required to be read out. These functions realize several advantages that extend recording time, reduce memory requirements, or a combination of one or more of these.

The digital camera according to the present invention can also simulate the operation of several cameras with one by sensing multiple events and storing high-speed video from each to different memory locations. For example, with a traditional 16 GB high speed digital camera, a user may be able to record only thirty seconds of a rocket launch. The present invention allows a user to divide the available memory into multiple “chunks” of memory, for example, into eight chunks of memory, each 2 GB long, and could thus record multiple launches with one camera. In order to accomplish this, the user could set an ICW at the exit of the rocket launcher, and specify that 2 GB of frames be recorded at each launch. After the camera records the first launch, it would resets and record seven more 2 GB launch events. Without the functionality afforded by the present invention, eight cameras would be required to record eight launches at high speed.

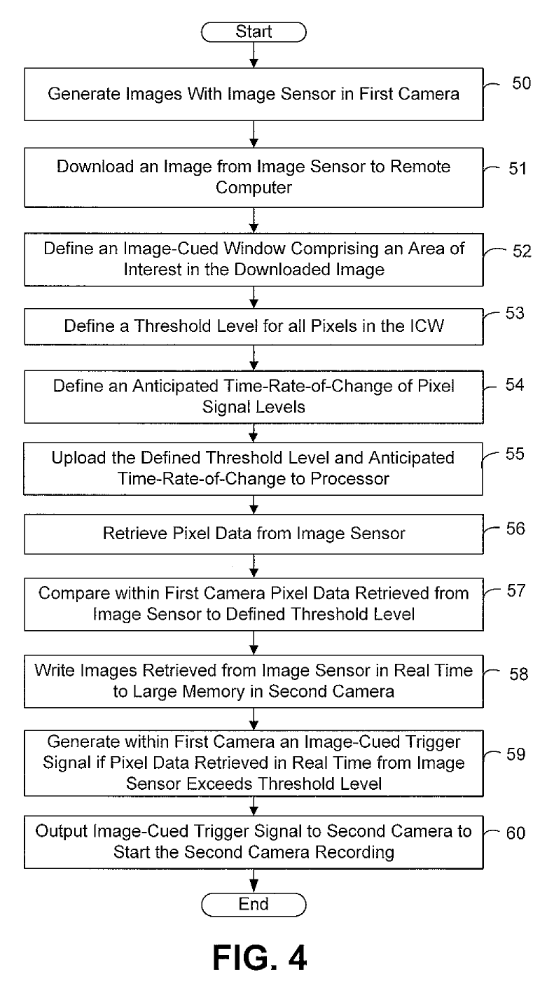

FIG. 4 is a flowchart that depicts exemplary architecture and functionality of the system illustrated in FIG. 3 in which a first digital camera 10 controls the operation of auxiliary equipment 30, which in this example is a second digital camera (not illustrated). Referring to step 50, the image sensor in the first high speed digital camera 10 generates images of at least 3×10⁵ pixels at greater than 200 frames-per-second. In step 51, the camera downloads an image to a remote computer 21 [FIG. 3]. In step 52, the user defines an image-cued window comprising an area of interest in the downloaded image, the area of interest comprising a plurality of adjacent pixels in the image in which an event of interest is expected to occur. In step 53, the user defines an upper and lower threshold level for all pixels in the area of interest. Referring to step 54, the user defines an anticipated time-rate-of-change of pixel signal levels. In step 55, the remote computer 21 [FIG. 3] uploads the defined thresholds and anticipated time-rate-of-change to the processor 13 [FIG. 3] in camera 10. Referring to step 56, the processor 13 retrieves pixel data in real time from the image sensor 11 [FIG. 3], and then [step 57] processor 13 [FIG. 3] in camera 10 compares the pixel data retrieved in real time from the image sensor 11 with the defined threshold levels. In step 58, the camera 10 writes images retrieved from the image sensor in real time to memory 32 located in auxiliary equipment 30, which in this example is a second high speed digital camera (not illustrated). In step 59, the camera 10 generates an image-cued trigger signal if pixel data received in real time from the image sensor 11 exceeds the threshold levels. In step 60, the camera 10 outputs the image-cued trigger signal to the second camera, to start the second camera recording.

This invention may be provided in other specific forms and embodiments without departing from the essential characteristics as described herein. The embodiment described is to be considered in all aspects as illustrative only and not restrictive in any manner.

As described above and shown in the associated drawings and exhibits, the present invention comprises a high-speed smart camera and method for high-speed image-cued triggering. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A method for processing high-speed digital images, comprising the steps of:
a. generating images with an image sensor within a first high-speed digital camera, wherein the images generated by the image sensor are at least 3×10⁵ pixels at greater than 60 frames-per-second;
b. downloading an image from the image sensor to a remote computer;
c. defining an image-cued window comprising an area of interest in the downloaded image, the area of interest comprising a plurality of adjacent pixels in the image in which an event of interest is expected to occur;
d. defining a threshold level for all pixels in the plurality, wherein the threshold level is at least one of: an upper threshold and a lower threshold;
e. uploading the defined threshold level to a processor within the camera
f. defining an anticipated time-rate-of-change of pixel signal levels;
g. retrieving pixel data in real time from the image sensor;
h. comparing within the first camera the pixel data retrieved in real time from the image sensor to the defined threshold level;
i. writing images retrieved from the image sensor in real time to large memory while the comparison is being performed.

2. The method of claim 1, wherein the first camera has a housing, and wherein the large memory is located outside of the first camera housing.

3. The method of claim 1, further comprising the step of generating within the first camera an image-cued trigger signal if pixel data retrieved in real time from the image sensor exceeds the threshold level.

4. The method of claim 3, further comprising the step of outputting the image-cued trigger signal to trigger external equipment.

5. The method of claim 4, wherein the external equipment comprises a second high speed digital camera.

6. The method of claim 5, wherein the second camera houses the large memory.

7. The method of claim 5, further comprising the step of recording real-time image data in the large memory and continuously overwriting it in circular buffer fashion until a trigger level is set.

8. The method of claim 7, further comprising the step of defining the portion of the available memory to be allocated to pre-trigger recording and post-trigger recording.

9. The method of claim 8, further comprising the step of outputting to a remote computer the defined portions of pre-trigger and post-trigger images.

10. The method of claim 7, wherein an address of memory in the circular buffer of large memory is decremented or incremented by one frame count when a trigger is received.

11. The method of claim 5, wherein multiple separate blocks of large memory are reserved for storage of multiple separate image sequences following detection of multiple separate out-of-threshold image-cued trigger events.

12. The method of claim 5, wherein multiple separate extended memory blocks are reserved for storage of multiple separate image sequences following detection of either out-of-threshold image-cued trigger events or a combination of external trigger events and image-cued trigger events.

13. The method of claim 5, wherein the processor is armed when pixel data retrieved in real time from the image sensor exceeds the threshold level.

14. The method of claim 13, further comprising the step of defining a second image-cued window and generating a trigger when data retrieved in real time from the image sensor for the second image-cued window exceeds the threshold level if the processor is armed.

15. The method of claim 14, further comprising the step of defining a maximum delay between image-cued window events and resetting the sequence when a first ICW is armed but a second ICW does not trigger before the expiration of the user-defined maximum delay.

16. The method of claim 13, in which multiple image-cued windows are armed in a specific sequence before a recording trigger can be generated.

17. A computer readable medium configured with control logic that causes a computer processor to execute the method comprising the steps of:
a. generating images with an image sensor within a first high-speed digital camera, wherein the first camera has a housing;
b. downloading an image from the image sensor to a remote computer;
c. defining an imaged-cued window comprising an area of interest in the downloaded image, the area of interest comprising a plurality of adjacent pixels in the image in which an event of interest is expected to occur;
d. defining a threshold level for all pixels in the plurality, wherein the threshold level is at least one of: an upper threshold and a lower threshold;
e. uploading the defined threshold level to a processor within the camera;
f. defining an anticipated time-rate-of-change of pixel signal levels.
g. retrieving pixel data in real time from the image sensor;
h. comparing within the first camera the pixel data retrieved in real time from the image sensor to the defined threshold level;
i. writing images retrieved from the image sensor in real time to large memory while the comparison is being performed, wherein the large memory is located outside of the first camera housing;
j. generating within the first camera an image-cued trigger signal if pixel data retrieved in real time from the image sensor exceeds the threshold level;
k. outputting the image-cued trigger signal to trigger external equipment.

18. The computer readable medium of claim 17, wherein the external equipment comprises a second high speed digital camera.

19. A system for processing real-time digital images comprising:
a camera comprising:
a camera housing;
an image sensor capable of generating images with at least 3×10⁵ pixels at greater than 60 frames-per-second;
processing means capable of providing control signals to the image sensor and processing retrieved imagery in a parallel pipelined fashion;
small memory for storing look-up tables or buffering data for external transmission; and
a digital interface to connect to a host computer or network;
wherein the image sensor, processing means, small memory, and digital interface are all housed within the camera housing;
auxiliary equipment external to the camera housing comprising extended memory for receiving data from the processing means; and
an external host computer or network.

20. The system of claim 19, wherein the auxiliary equipment comprises a second high speed digital camera.
